(19) United States
(12) Patent Application Publication
(10) Pub. No.: US 2012/0130539 A1
(43) Pub. Date: May 24, 2012

(54) ROBOT CONTROL SYSTEM AND CONTROL METHOD USING THE SAME

(75) Inventors: Do Ik KIM, Seoul (KR); Young Su CHA, Busan (KR); Eun Ho SEO, Seoul (KR); Bum Jae YOU, Seoul (KR)

(73) Assignee: KOREA INSTITUTE OF SCIENCE AND TECHNOLOGY, Seoul (KR)

(21) Appl. No.: 13/084,383

(22) Filed: Apr. 11, 2011

(30) Foreign Application Priority Data
Nov. 23, 2010 (KR) 10-2010-0116680

(51) Int. Cl. G05B 19/418; G06F 19/00

(52) U.S. Cl. 700/248; 700/245; 700/249; 700/258; 901/1; 901/46

(57) ABSTRACT

Provided is a robot control system including a robot which receives a final operation signal computed by a mobile terminal and includes one or more driving machines operated according to the received final operation signal, and the mobile terminal which receives a status signal of the robot and controls the robot by generating the final operation signal for directly driving the one or more driving machines included in the robot.

### CROSS-REFERENCE TO RELATED APPLICATION

This application claims priority to Korean Patent Application No. 10-2010-0116680, filed on Nov. 23, 2010, and all the benefits accruing therefrom under 35 U.S.C. §119, the contents of which in its entirety are herein incorporated by reference.

### BACKGROUND

1. Field

This disclosure relates to a robot control system for controlling a robot in which a main controller is not mounted using a mobile terminal through a wired or wireless network and a robot control method using the same.

2. Description of the Related Art

Recently, with the extension of the applications of robots, robots are used in various fields, including everyday lives. In an existing robot, a main controller is mounted in the robot, and a driving machine of the robot is operated using an algorithm which is stored in the main controller. Unlike the existing robot which has an independent system as described above, there has been an increasing demand by users on executing a robot using a mobile terminal.

### SUMMARY

This disclosure is directed to providing a robot control system for controlling a robot in which a main controller is not mounted using a mobile terminal through a wired or wireless network and a robot control method using the same.

In one aspect, there is provided a robot control system including: a robot which receives a final operation signal computed by a mobile terminal and includes one or more driving machines operated according to the received final operation signal; and the mobile terminal which receives a status signal of the robot and controls the robot by generating the final operation signal for directly driving the one or more driving machines included in the robot.

The mobile terminal may include: a communication unit which communicates with the robot through a wired or wireless network; a sensing unit which senses the status of the robot; a computation unit which generates the final operation signal for driving the robot through an algorithm for the robot according to the status signal of the robot received through the communication unit or the sensing unit; and a controller which directly drives the one or more driving machines included in the robot by transmitting the final operation signal received from the computation unit to the robot through the communication unit.

The sensing unit may include one or more of a gyro sensor, an accelerometric sensor, a geomagnetic sensor, a touch sensor, a proximity sensor, and a camera sensor.

The mobile terminal may generate the final operation signal for directly driving the one or more driving machines included in the robot through the algorithm for the robot using structural definition specifications of the robot stored therein or structural definition specifications of the robot received from the robot.

The robot may be constituted by a plurality of robots, and the mobile terminal may control each of the plurality of robots by generating a final operation signal for driving a driving machine of each of the robots.

The mobile terminal may be constituted by a plurality of mobile terminals, and the robot may receive the final operation signal from each of the mobile terminals so as to operate the one or more driving machines.

The mobile terminal may include: a first mobile terminal for directly driving the one or more driving machines included in the robot through the final operation signal; and a second mobile terminal for transmitting a control command to control the first mobile terminal.

In another aspect, there is provided a robot control method including: receiving a status signal of a robot by a mobile terminal; generating a final operation signal for driving the robot through an algorithm for the robot according to the status signal of the robot received by the mobile terminal; and directly controlling one or more driving machines included in the robot by transmitting the final operation signal to the robot by the mobile terminal.

The generating of the final operation signal may include: generating the final operation signal for driving the robot through the algorithm for the robot according to the status signal of the robot received by a communication unit or a sensing unit.

The generating of the final operation signal may include: storing structural definition specifications of the robot in the mobile terminal; and generating the final operation signal for driving the robot through the algorithm for the robot using the stored structural definition specifications of the robot.

The generating of the final operation signal may include: allowing structural definition specifications of the robot to be received from the robot to the mobile terminal; and generating the final operation signal for driving the robot through the algorithm for the robot using the received structural definition specifications of the robot.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a diagram illustrating the configuration of a robot control system according to an embodiment;

FIG. 2 is a flowchart showing a robot control process using a robot control system according to an embodiment;

FIG. 3 is a diagram illustrating a robot control system including one or more robots according an embodiment;

FIG. 4 is a diagram illustrating a robot control system including one or more mobile terminals according to an embodiment; and

FIG. 5 is a diagram illustrating a robot control system including one or more mobile terminals according to another embodiment.

### DETAILED DESCRIPTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals denote like elements. The shape, size and regions, and the like, of the drawing may be exaggerated for clarity.

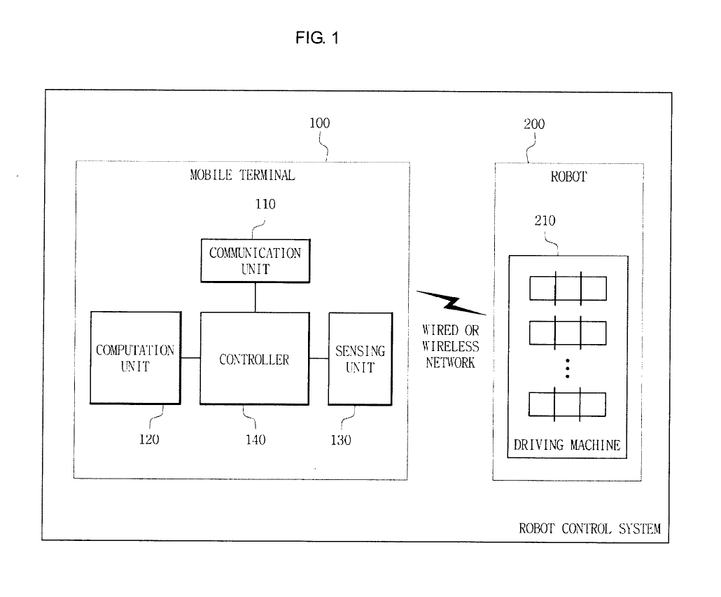

FIG. 1 is a diagram illustrating the configuration of a robot control system according to an embodiment.

Referring to FIG. 1, a robot control system according to an embodiment includes a mobile terminal 100 for controlling a robot and a robot 200 in which a main controller is not mounted. The mobile terminal 100 includes a communication unit 110, a computation unit 120, a sensing unit 130, and a controller 140, and the robot 200 includes one or more driving machines 210. The components illustrated in FIG. 1 are not essentially necessary, and a robot control system may have more components.

The mobile terminal 100 performs functions of receiving a status signal of the robot 200, and generating a final operation signal for directly driving the one or more driving machines 210 included in the robot 200 depending on a user's instruction input through a user interface to control the robot. The final operation signal is a completed command signal for directly controlling the driving machines 210 of the robot 200 without additional computation by the robot 200.

The communication unit 110 of the mobile terminal 100 communicates with the robot 200 through a wired or wireless network, receives the status signal from the robot 200, and transmits a remote control signal such as the final operation signal to the robot 200. The status signal of the robot 200 may include information on motions that the robot 200 can perform, mechanical statuses and the current status of the robot 200, or the like.

The communication unit 110 may receive the status information of the robot 200 periodically or aperiodically when there is a user's instruction. The computation unit 120 of the mobile terminal 100 generates the final operation signal for driving the robot through an algorithm for the robot according to the status signal of the robot received through the communication unit 110.

The mobile terminal 100 stores a robot driving algorithm for controlling the robot 200 and operation command information used for controlling the driving machines of the robot in advance. The computation unit 120 generates an operation signal for controlling the driving machine 210 of the rotor 200 through the algorithm or the operation command information.

The mobile terminal 100 may be set to control one or more robots 200, and structural definition specifications of the robots for driving the different robots 200 may be stored in the mobile terminal 100 in advance or may be received during communication with the robots 200 through the communication unit 110. The computation unit 120 determines an algorithm and a driving method corresponding to each robot 200 and generates the final operation signal.

The sensing unit 130 senses the status of the robot 200 using a sensor, and transmits the status signal of the robot 200 to the computation unit 120. The sensing unit 130 may include one or more of a gyro sensor, an accelerometric sensor, a geomagnetic sensor, a touch sensor, a proximity sensor, and a camera sensor. The controller 140 transmits the final operation signal generated by the computation unit 120 to the robot 200 through the communication unit 110, thereby performing wired or wireless remote control for directly driving the one or more driving machines 210 included in the robot 200. Therefore, the controller 140 of the mobile terminal 100 performs a CPU function of the robot 200 and drives each driving machine included in the robot 200 through the wired or wireless network.

A plurality of the mobile terminals 100 may also be provided to control the robot 200, and the plurality of the mobile terminals may be arranged in series or in parallel to transmit a remote wired or wireless control signal which is the final operation signal to the robot 200 in various manners.

The robot 200 includes the one or more driving machines 210 for implementing driving operations, and receives the final operation signal from the mobile terminal 100 so as to operate the one or more driving machines 210 depending on the received final operation signal. The robot 200 may further include a driving machine controller that receives the final operation signal from the mobile terminal 100 to operate the driving machine 210. Without a main controller for directly generating a control signal mounted, the robot 200 receives the final operation signal from the mobile terminal 100 and is controlled by the final operation signal.

The robot 200 may be constituted by a plurality of identical or different robots, and each driving machine may be operated depending on the control signals received from one or more mobile terminals 100.

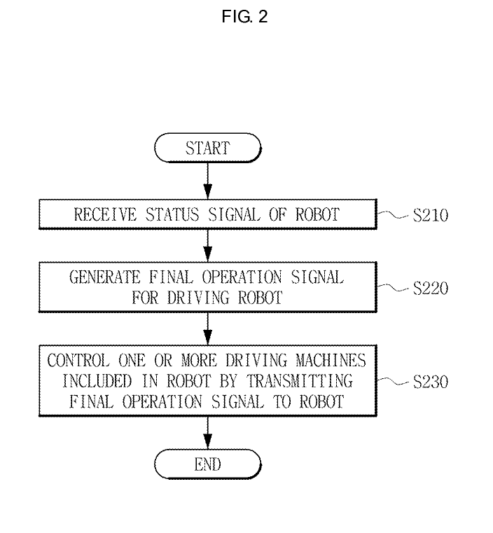

FIG. 2 is a flowchart showing a robot control process using a robot control system according to an embodiment.

Referring to FIG. 2, the mobile terminal receives the status signal of the robot (S210) and generates the final operation signal for driving the robot through the algorithm for the robot according to the received status signal of the robot (S220).

The mobile terminal transmits the final operation signal to the robot and directly controls the one or more driving machines included in the robot (S230). The mobile terminal may transmit the status signal of the robot sensed by the sensor to the computation unit 120, and the computation unit 120 may generate a final operation signal for driving the robot so as to directly control the one or more driving machines included in the robot.

Structural definition specifications of the robot for driving different robots may be stored in the mobile terminal in advance, or may be received from the robots, so that the mobile terminal can generate the final operation signals depending on algorithms and driving methods of the corresponding robots.

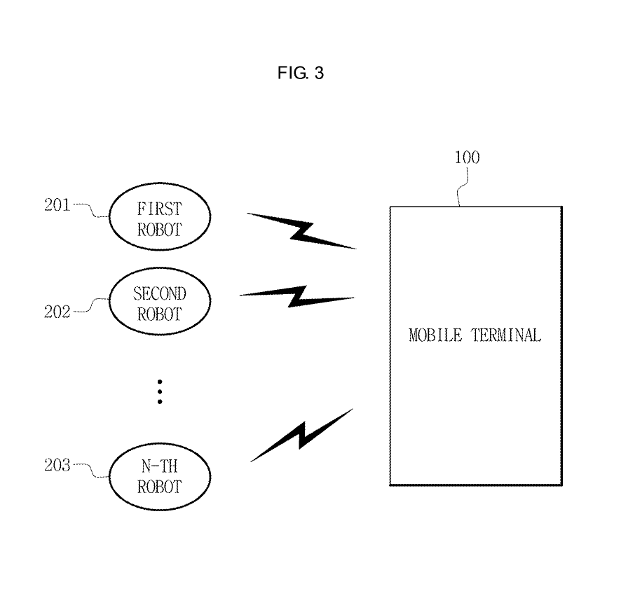

FIG. 3 is a diagram illustrating a robot control system including one or more robots according to an embodiment.

Referring to FIG. 3, the robot may be constituted by a plurality of identical or different robots 201, 202, 203.

The mobile terminal 100 may transmit the final operation signals for controlling the corresponding robots 201, 202, 203 through the wired or wireless network. The mobile terminal 100 may transmit the final operation signal for performing the same operation to each of the robots 201, 202, 203 or transmit different final operation signals for performing different operations to the corresponding robots 201, 202, 203 depending on settings. In addition, the mobile terminal 100 may control the robots 201, 202, 203 by transmitting final operation signals for causing the robots 201, 202, 203 to operate simultaneously or to operate at different times, depending on settings.

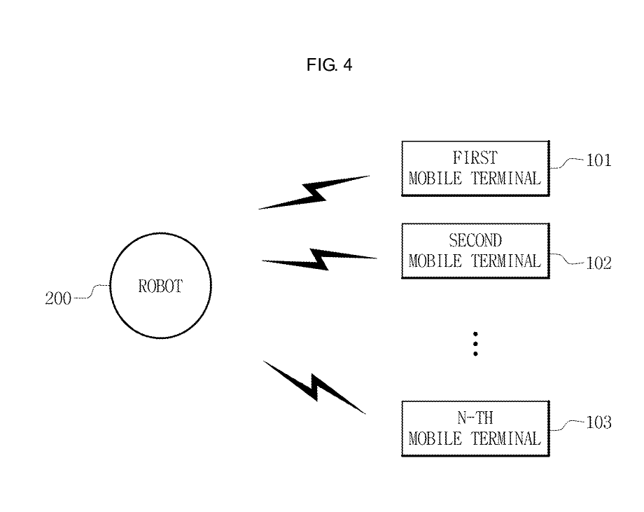

FIG. 4 is a diagram illustrating a robot control system including one or more mobile terminals according to an embodiment.

Referring to FIG. 4, the mobile terminal may be constituted by a plurality of mobile terminals 101, 102, 103, and the plurality of mobile terminals 101, 102, 103 are arranged in parallel to transmit the final operation signals to a single robot 200 through the wired or wireless network. The plurality of mobile terminals 101, 102, 103 may transmit different final operation signals to operate the different driving machines included in the robot 200 or transmit different final operation signals to cause the same driving machine included in the robot 200 to perform different operations.

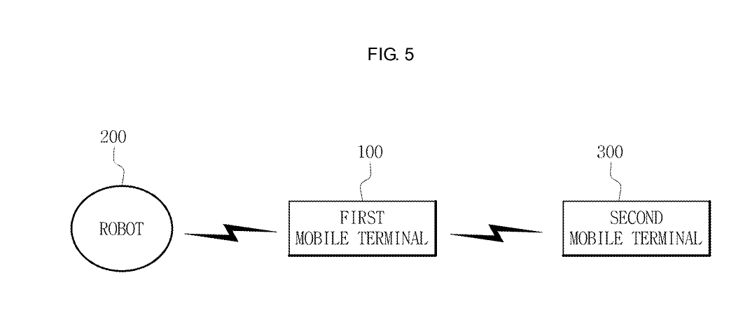

FIG. 5 is a diagram illustrating a robot control system including one or more mobile terminals according to another embodiment.

Referring to FIG. 5, the mobile terminal may be constituted by a plurality of mobile terminals 100, 300. The plurality of mobile terminals 100, 300 may be arranged in series to control a single robot 200. The first mobile terminal 100 transmits a final operation signal to the robot 200 to operate the driving machine included in the robot 200, and the second mobile terminal 300 transmits a control command to control the first mobile terminal 100. The control command transmitted from the second mobile terminal 300 may be in a final operation signal form which is capable of operating the robot 200. Otherwise, the control command of the second mobile terminal 300 may be in a signal form for operating the controller of the first mobile terminal 100 to control the controller of the first mobile terminal 100 to generate the final operation signal for operating the robot 200.

The first mobile terminal 100 may be integrally combined with the robot 200, and by remotely controlling the first mobile terminal 100 through the second mobile terminal 200, the robot 200 may be finally controlled.

According to the robot control system of the present disclosure, since a main controller is not mounted in the robot, reduction in volume and cost may be achieved.

In addition, since the robot is controlled through the wired or wireless network using the mobile terminal, there is an advantage in that the robot can be controlled without requiring additional hardwares or application programs.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

What is claimed is:

1. A robot control system comprising:
a robot which receives a final operation signal computed by a mobile terminal and includes one or more driving machines operated according to the received final operation signal; and
the mobile terminal which receives a status signal of the robot and controls the robot by generating the final operation signal for directly driving the one or more driving machines included in the robot.

2. The robot control system according to claim 1, wherein the mobile terminal includes:
a communication unit which communicates with the robot through a wired or wireless network;
a sensing unit which senses the status of the robot;
a computation unit which generates the final operation signal for driving the robot through an algorithm for the robot according to the status signal of the robot received through the communication unit or the sensing unit; and
a controller which directly drives the one or more driving machines included in the robot by transmitting the final operation signal received from the computation unit to the robot through the communication unit.

3. The robot control system according to claim 2, wherein the sensing unit includes one or more of a gyro sensor, an accelerometric sensor, a geomagnetic sensor, a touch sensor, a proximity sensor, and a camera sensor.

4. The robot control system according to claim 1, wherein the mobile terminal generates the final operation signal for directly driving the one or more driving machines included in the robot through the algorithm for the robot using structural definition specifications of the robot stored therein or structural definition specifications of the robot received from the robot.

5. The robot control system according to claim 1, wherein the robot is constituted by a plurality of robots, and the mobile terminal controls each of the plurality of robots by generating a final operation signal for driving a driving machine of each of the robots.

6. The robot control system according to claim 1, wherein the mobile terminal is constituted by a plurality of mobile terminals, and the robot receives the final operation signal from each of the mobile terminals so as to operate the one or more driving machines.

7. The robot control system according to claim 1, wherein the mobile terminal includes:
a first mobile terminal for directly driving the one or more driving machines included in the robot through the final operation signal; and
a second mobile terminal for transmitting a control command to control the first mobile terminal.

8. A robot control method comprising:
receiving a status signal of a robot by a mobile terminal;
generating a final operation signal for driving the robot through an algorithm for the robot according to the status signal of the robot received by the mobile terminal; and
directly controlling one or more driving machines included in the robot by transmitting the final operation signal to the robot by the mobile terminal.

9. The robot control method according to claim 8, wherein the generating of the final operation signal includes:
generating the final operation signal for driving the robot through the algorithm for the robot according to the status signal of the robot received by a communication unit or a sensing unit.

10. The robot control method according to claim 8, wherein the generating of the final operation signal includes:
storing structural definition specifications of the robot in the mobile terminal; and
generating the final operation signal for driving the robot through the algorithm for the robot using the stored structural definition specifications of the robot.

11. The robot control method according to claim 8, wherein the generating of the final operation signal includes:
allowing structural definition specifications of the robot to be received from the robot to the mobile terminal; and
generating the final operation signal for driving the robot through the algorithm for the robot using the received structural definition specifications of the robot.
